(19) United States
(12) Patent Application Publication
(10) Pub. No.: US 2023/0118845 A1
(43) Pub. Date: Apr. 20, 2023

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventors: Junichi SHIMIZU, Kanagawa (JP); Akinobu YAMAGUCHI, Kanagawa (JP); Kunihiko KOBAYASHI, Kanagawa (JP); Shintaro ADACHI, Kanagawa (JP); Shinya NAKAMURA, Kanagawa (JP); Masanori YOSHIZUKA, Kanagawa (JP); Akane ABE, Kanagawa (JP); Naomi TAKAHASHI, Kanagawa (JP)

(73) Assignee: FUJIFILM Business Innovation Corp., Tokyo (JP)

(21) Appl. No.: 17/718,320

(22) Filed: Apr. 12, 2022

(30) Foreign Application Priority Data
Oct. 20, 2021 (JP) 2021-171908

(51) Int. Cl. G06V 30/416; G06V 30/418; G06V 30/414; G06V 30/18

(52) U.S. Cl. CPC G06V 30/416; G06V 30/418; G06V 30/414; G06V 30/18

(57) ABSTRACT

An information processing apparatus includes a processor configured to acquire a plurality of scanned images obtained by scanning a bundle of paper media having a plurality of pages, extract feature information indicating a feature of a scanned image including at least a type of a corresponding document of each scanned image among the plurality of scanned images, derive, on the basis of the feature information of each of the plurality of scanned images, information that indicates relevance and increases as the relevance related to the feature information between a first scanned image and a second scanned image scanned later than the first scanned image among the plurality of scanned images, increases, correlate the information indicating the relevance with the second scanned image, and generate scanned image group information indicating the plurality of scanned images including the scanned image with which the information indicating the relevance is correlated.

### CROSS-REFERENCE TO RELATED APPLICATIONS

This application is based on and claims priority under 35 USC 119 from Japanese Patent Application No. 2021-171908 filed Oct. 20, 2021.

### BACKGROUND

### (i) Technical Field

The present invention relates to an information processing apparatus and a non-transitory computer readable medium storing an information processing program.

### (ii) Related Art

JP2015-102934A discloses an image forming apparatus having a scanner function and including a title detection mean that detects a title of a document read by the scanner function, a title file creation mean that creates a file having a title which is text of the title as a file name, and a title image data storage mean that stores image data of the document corresponding to a range of the title in the title file.

### SUMMARY

Paper media documents written by a user may be often scanned by an image scanning apparatus or the like to be converted into electronic data and are stored in a storage mean such as a storage to be managed. In this case, documents having a predetermined commonality may be collectively managed as a group of documents. In a case where processes are performed on electronic data for various purposes, an optical character recognition (OCR) process of recognizing written text from a document image may be performed.

Incidentally, for example, a plurality of scanned images having relevance may be included in a scanned image group in which a plurality of images (hereinafter, referred to as scanned images) obtained by scanning a bundle of paper media having a plurality of pages in page units are included in a group of documents managed collectively. In this case, the scanned image group may be provided in a form in which the scanned images having relevance can be identified. However, by identifying a scanned image having relevance from a title of the document, the scanned image may be identified to have different relevance even though the scanned image has the relevance. Therefore, there is room for improvement in obtaining a scanned image group in which a plurality of scanned images having relevance can be identified.

Aspects of non-limiting embodiments of the present disclosure relate to an information processing apparatus and a non-transitory computer readable medium storing an information processing program capable of obtaining an identifiable scanned image group in which scanned images having relevance are not identified as having the relevance compared with a case where related scanned images are identified from a title of a document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire a plurality of scanned images obtained by scanning a bundle of paper media having a plurality of pages, extract feature information indicating a feature of a scanned image including at least a type of a corresponding document of each scanned image among the plurality of scanned images, derive, on the basis of the feature information of each of the plurality of scanned images, information that indicates relevance and increases as the relevance related to the feature information between a first scanned image and a second scanned image scanned later than the first scanned image among the plurality of scanned images, increases, correlate the information indicating the relevance with the second scanned image, and generate scanned image group information indicating the plurality of scanned images including the scanned image with which the information indicating the relevance is correlated.

### BRIEF DESCRIPTION OF THE DRAWINGS

Exemplary embodiment(s) of the present invention will be described in detail based on the following figures, wherein:

FIG. 1 is a diagram showing an example of an electrical configuration of an information processing apparatus according to a first exemplary embodiment;

FIG. 2 is a diagram showing an example of a functional configuration of the information processing apparatus according to the first exemplary embodiment;

FIG. 3 is a block diagram showing an example of a configuration of an information processing system according to the first exemplary embodiment;

FIG. 4 is a schematic diagram showing an example of a state in information processing according to the first exemplary embodiment;

FIG. 5 is a diagram showing an example of a table related to the types of slips according to the first exemplary embodiment;

FIG. 6 is a diagram showing another example of a table related to the types of slips according to the first exemplary embodiment;

FIG. 7 is a diagram showing an example of a table related to relevance according to the first exemplary embodiment;

FIG. 8 is a schematic diagram showing an example of a state in information processing according to the first exemplary embodiment;

FIG. 9 is a schematic diagram showing an example of a state in information processing according to the first exemplary embodiment;

FIG. 10 is a schematic diagram showing an example of a state in information processing according to the first exemplary embodiment;

FIG. 11 is a flowchart showing a flow of information processing according to the first exemplary embodiment;

FIG. 12 is a flowchart showing a flow of a slip type determination process according to the first exemplary embodiment;

FIG. 13 is a flowchart showing a flow of a determination process of relevance of a scanned image according to the first exemplary embodiment;

FIG. 14 is a diagram showing an example of a table in which conditions for specifying relevance are determined by using the relevance degree according to a second exemplary embodiment; and

FIG. 15 is a flowchart showing a flow of a determination process of relevance of a scanned image according to the second exemplary embodiment.

### DETAILED DESCRIPTION

Hereinafter, examples of exemplary embodiments for embodying the technique of the present disclosure will be described in detail with reference to the drawings. Constituents and processes in which operations, actions, and functions have the same function may be given the same reference numeral throughout the drawings, and repeated description may be omitted. Each drawing is only schematically shown to the extent that the technique of the present disclosure can be fully understood. Therefore, the technique of the present disclosure is not limited to the illustrated examples. In the present exemplary embodiment, the description may of a configuration not directly related to the present invention or the well-known configuration may be omitted.

As an example, an information processing apparatus 10 according to the present exemplary embodiment will be described as a server that manages data obtained by scanning documents, slips, and the like. However, the present disclosure is not limited to this. The information processing apparatus 10 may be mounted in a multifunction peripheral having functions such as a print function, a copy function, a scan function, and a facsimile function, or may be a terminal such as a personal computer.

In the present exemplary embodiment, a group of documents will be referred to as a “document bundle”. The document bundle may be one document. Dividing a document bundle that is collectively managed into different bundles for a certain purpose will be referred to as “division”.

### First Exemplary Embodiment

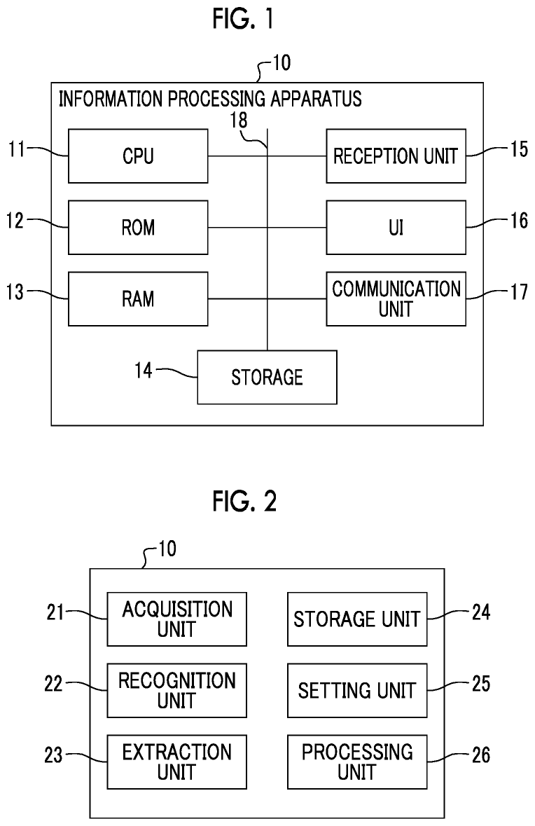

An information processing apparatus, an information processing system, and an information processing program according to the present exemplary embodiment will be described with reference to FIGS. 1 to 13.

FIG. 1 shows an example of an electrical configuration of the information processing apparatus 10. The information processing apparatus 10 can be realized by a configuration including, for example, a general-purpose computer device such as a server or a personal computer (PC). As shown in FIG. 1, the information processing apparatus 10 includes a central processing unit (CPU) 11, a read only memory (ROM) 12, a random access memory (RAM) 13, a storage 14, a reception unit 15, a user interface (UI) 16, and a communication unit 17. The CPU 11, the ROM 12, the RAM 13, the storage 14, the reception unit 15, the UI 16, and the communication unit 17 are connected to each other via a bus 18. Here, the CPU 11 is an example of a processor according to the technique of the present disclosure.

The CPU 11 collectively controls the entire information processing apparatus 10. The ROM 12 stores various programs, data, and the like including a division process program used in the present exemplary embodiment. The RAM 13 is a memory used as a work area when various programs are executed. The CPU 11 performs various information processing by loading a program stored in the ROM 12 to the RAM 13 and executing the program. The storage 14 is, for example, a hard disk drive (HDD), a solid state drive (SSD), a flash memory, or the like. An information processing program or the like may be stored in the storage 14. The reception unit 15 receives, for example, a plurality of scanned images in units of pages in which a document bundle is scanned. The reception unit 15 is, for example, a Universal Serial Bus (USB). The UI 16 is, for example, a touch panel type liquid crystal screen, and receives instructions from a user, for example. The UI 16 may display image data or the like associated with information processing (for example, division process) that will be described later and is executed by the information processing apparatus 10. The communication unit 17 is an interface for connection to a network that will be described later, and performs transmission and reception of data with, for example, an image processing apparatus. Each of the storage 14, the reception unit 15, the UI 16, and the communication unit 17 is not necessarily provided in the information processing apparatus 10, but may be selected and provided according to a form of the information processing apparatus 10.

Next, a functional configuration of the information processing apparatus 10 will be described with reference to FIG. 2. FIG. 2 is a block diagram showing an example of a functional configuration of the information processing apparatus 10 according to the present exemplary embodiment.

As shown in FIG. 2, the information processing apparatus 10 includes an acquisition unit 21, a recognition unit 22, an extraction unit 23, a storage unit 24, a setting unit 25, and a processing unit 26. The CPU 11 executes the information processing program to function as the acquisition unit 21, the recognition unit 22, the extraction unit 23, the storage unit 24, the setting unit 25, and the processing unit 26.

The acquisition unit 21 acquires images (scanned images) in units of pages in which paper media including a plurality of documents are scanned. For example, this corresponds to acquiring a document bundle, that is, a plurality of scanned images via the reception unit 15 or the communication unit 17.

The recognition unit 22 recognizes each feature indicated by each scanned image. Specifically, an OCR process is executed on the scanned image and text included in the scanned image is recognized. The recognition unit executes a document configuration analysis process on the scanned image and recognizes a page configuration in the scanned image. For example, in the document configuration analysis process, a size and a layout of text are analyzed, and a configuration is recognized for each page. A configuration may be recognized for each page by analyzing formats of symbols and numbers. A configuration may be recognized for each page by analyzing a structure of an image such as a ruled line.

The extraction unit 23 extracts feature information indicating characteristics of the scanned image from the recognized scanned image. The feature information is information indicating at least one of the text or the image shown by the scanned image. The feature information includes attribute information and configuration information that characteristically represent a corresponding page of the scanned image. Examples of the attribute information include information such as a title, a date, and a slip number. That is, the attribute information can be extracted as feature information indicating a feature related to an attribute of the document by text included in the scanned image subjected to character recognition by the recognition unit 22. Specifically, the attribute information is extracted by extracting text information from the scanned image subjected to an OCR process. A key value extraction process may be applied to a process of extracting text information as the attribute information.

The key value extraction process is a process of searching for a predetermined item (key) for the scanned image and extracting a value corresponding to a found item. Through the key value extraction process, various types of information in the document such as a title, a date, and a slip number are extracted as attribute information. The item (key) may be specified by text in the scanned image subjected to an OCR process, or may be specified by a position and a size of a text image on the scanned image. A value corresponding to the item may be specified by text specified as the item or text around the item. For example, the title has a feature specific to the title, such as being written in text having a size larger than a size of other text at an upper part of a corresponding page (scanned image). By performing a process of extracting a title from the scanned image by using this title-specific feature, that is, the key value extraction process of extracting a title from the scanned image subjected to an OCR process, the title can be extracted from the scanned image. In the following description, among attribute information extraction processes using the key value extraction process, a process of extracting a title will be referred to as a title extraction process.

An example of the configuration information is information such as chapters, indentation, font sizes, symbols, and ruled lines, which are configurations of a corresponding page in a document that is a target of a scanned image. That is, the configuration information can be extracted as feature information indicating features related to a configuration of a scanned image by a size and a layout of text included in the scanned image subjected to character recognition by the recognition unit 22 and a size and a layout of figures.

The recognition unit 22 does not necessarily have to be provided in the information processing apparatus 10, and may be supplied with a scanned image subjected to a recognition process from the outside.

The processing unit 26 sets a group of candidate scanned images (hereinafter referred to as “division candidate bundle”) for dividing a document bundle at a division position derived by using the feature information for each page, and performs an integration process of integrating related scanned images, for example, according to a user's determination. In the present exemplary embodiment, as described above, the functions of the recognition unit 22, the extraction unit 23, and the processing unit 26 are realized by software based on an information processing program. However, the present exemplary embodiment is not limited to this, and the functions may be realized by hardware using a dedicated LSI such as an application specific integrated circuit (ASIC).

The storage unit 24 is realized by, for example, the storage 14, and stores results processed by the recognition unit 22, the extraction unit 23, the processing unit 26, or the like. The setting unit 25 is realized by, for example, the UI 16, and a user sets conditions or the like for information processing executed in the information processing apparatus 10.

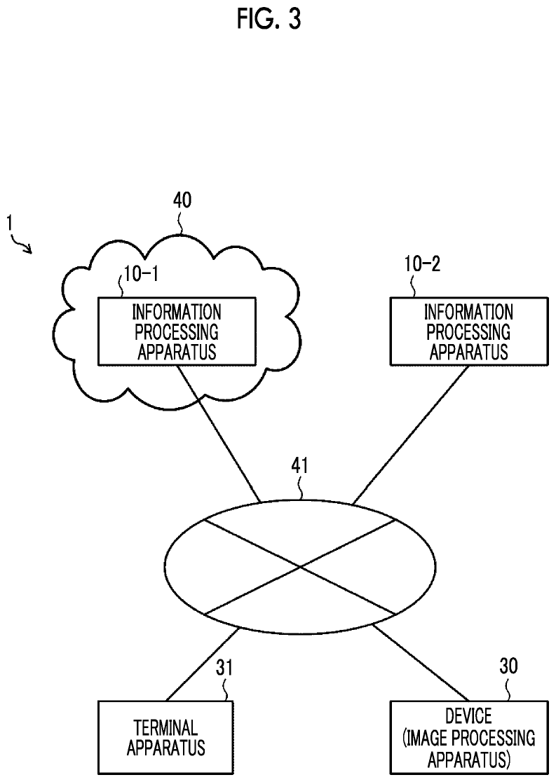

Next, the information processing system 1 according to the present exemplary embodiment will be described with reference to FIG. 3. As shown in FIG. 3, the information processing system 1 includes information processing apparatuses 10-1 and 10-2, a cloud 40, a network 41, an image processing apparatus 30, and a terminal apparatus 31. However, the information processing system 1 does not have to include all of these constituents, and may be configured by selecting necessary constituents according to the purpose, system conditions, and the like.

The network 41 is, for example, an IP network, and is a system for connecting various apparatuses to each other. A connection form of the network 41 may be wired or wireless, and may be a premises network such as a local area network (LAN). The cloud 40 is a system that provides various services via the network 41 such as an IP network. Each of the information processing apparatuses 10-1 and 10-2 is an apparatus having the same functions as the information processing apparatus 10, and a form in which the information processing apparatus 10-1 is disposed on the cloud 40 and a form in which the information processing apparatus 10-2 is disposed on the network 41 are shown. That is, an example in which the information processing apparatus 10-1 is connected to the cloud 40 via the communication unit 17 and an example in which the information processing apparatus 10-2 is connected to the network 41 via the communication unit 17 are shown. In the example shown in FIG. 3, the information processing apparatuses 10-1 and 10-2 are implemented by a server as an example. However, the present exemplary embodiment is not limited to this, and the information processing apparatus 10-1 or 10-2 may be used stand-alone.

The image processing apparatus 30 is a multifunction peripheral connected to the cloud 40 or the network 41 and having, for example, a scanning (image scanning) function, acquires a plurality of scanned images scanned as a document bundle, and sends data regarding the plurality of acquired scanned images to the information processing apparatus 10-1 or 10-2. In this case, each scanned image may be subjected to a recognition process such as an OCR process and then sent to the information processing apparatus 10-1 or 10-2. The terminal apparatus 31 is, for example, a personal computer (PC), and, in one form of the information processing system 1, controls the information processing apparatus 10-1 or 10-2 and the image processing apparatus 30 and receives results processed by the information processing apparatus 10-1 or 10-2.

Incidentally, in the document processing business, a user may want to collectively handle, as one document bundle, a first document that is a slip such as a standard document and a second document that is a related document related to the first document, such as “estimate” and “estimation details” indicating details of the estimate. On the other hand, for example, one project unit may be processed as a document bundle without being aware of a plurality of documents such as the first document and the second document described above. In this case, for example, when a document bundle is wanted to be handled as an estimate and documents related to the estimate, it is also assumed that it is required to divide the estimate and the documents related to the estimate into individual document bundles.

In a case where a document bundle is divided, it is conceivable to divide the document bundle into individual document bundles associated with a title on the basis of the title extracted from a plurality of scanned images subjected to an OCR process. However, in a case where the document bundle is divided by the title, the document bundle may be divided into a plurality of document bundles not intended by a user. That is, a document bundle managed collectively may include a plurality of r scanned images having relevance. However, by identifying a scanned image having relevance from a title, the scanned image may be recognized to have different relevance even though the scanned image has the relevance.

Therefore, in the present disclosure, information indicating derived relevance is correlated with a scanned image on the basis of feature information of each of a plurality of scanned images. The information indicating the relevance is information in which relevance increases as the relevance related to feature information between a first scanned image and a second scanned image after the first scanned image, different from the first scanned image, among a plurality of scanned images, increases. The information indicating derived relevance is correlated with the second scanned image. Information indicating a plurality of scanned images including the scanned image with which the information indicating the relevance is correlated is generated and stored. Consequently, it is possible to reduce a case where scanned images having relevance are not identified as having the relevance compared with a case where the scanned images are identified by a title.

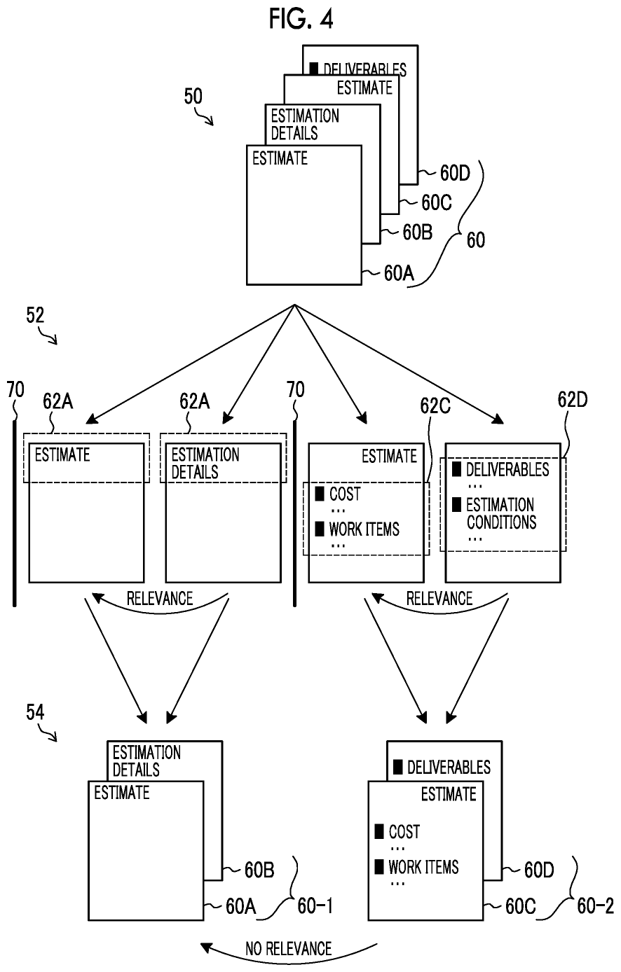

Next, the information processing apparatus according to the present exemplary embodiment will be described with reference to FIGS. 4 to 7.

FIG. 4 is a schematic diagram showing a flow of information processing executed by the information processing apparatus 10. In FIG. 4, the information processing apparatus 10 is assumed to have already acquired a document bundle that is a plurality of scanned images subjected to a recognition process such as an OCR process, and the document bundle is stored in the storage 14 as an example. It is assumed that the slip type that is a division target in the document bundle is designated by a user. The slip type is not limited to being designated by the user, and may be set in advance.

Information indicating the slip type designated by the user is an example of designated feature information of the present disclosure. A slip is an example of a corresponding document of a scanned image of the present disclosure, and the slip type is an example of the type of the corresponding document of the scanned image of the present disclosure.

FIG. 4 shows a state in information processing according to the present exemplary embodiment. A state 50 is a state related to a document bundle, that is, documents in which a plurality of scanned images are collected. A state 52 indicates a state between scanned images having relevance in a document bundle 60. A state 54 indicates a state in which scanned images having relevance are individually integrated into a document bundle.

In the example shown in state 50, the document bundle 60 including four scanned images 60A to 60D is shown.

In the information processing according to the present exemplary embodiment, feature information is extracted from each of the scanned images 60A to 60D included in the document bundle 60. Relevance between the scanned images is derived by using the extracted feature information. First, the title extraction process described above is executed in the process of extracting attribute information as the feature information.

Incidentally, a page (scanned image) including a title is more likely to be the first page of one document bundle compared with a page not including the title. In a case where the title is a representative title that specifies the type of slip, a page including the representative title is more likely to be the first page of one document bundle compared with a page not including the representative title. The title may include information indicating the type of slip, and each of scanned images may specify, for example, the type of slip (an estimate, an invoice, or the like) by the extracted title. In other words, it is possible to specify one slip by extracting the title. Therefore, a page including the title indicating the type of slip is likely to be the first page of a division candidate to be divided into different document bundles. There is a high probability that a boundary between the first page of the division candidate and the previous page may be a boundary for division into different document bundles. Therefore, in the present exemplary embodiment, the page including the representative title is set as a page of a division candidate to be divided as a different document bundle. A boundary between the first page of the division candidate and the previous page is set as a boundary for division into a plurality of different document bundles. In a case where the slip type in a scanned image matches the slip type designated by the user, the corresponding page is determined as a page of the division candidate, and a boundary between the page and the previous page is determined.

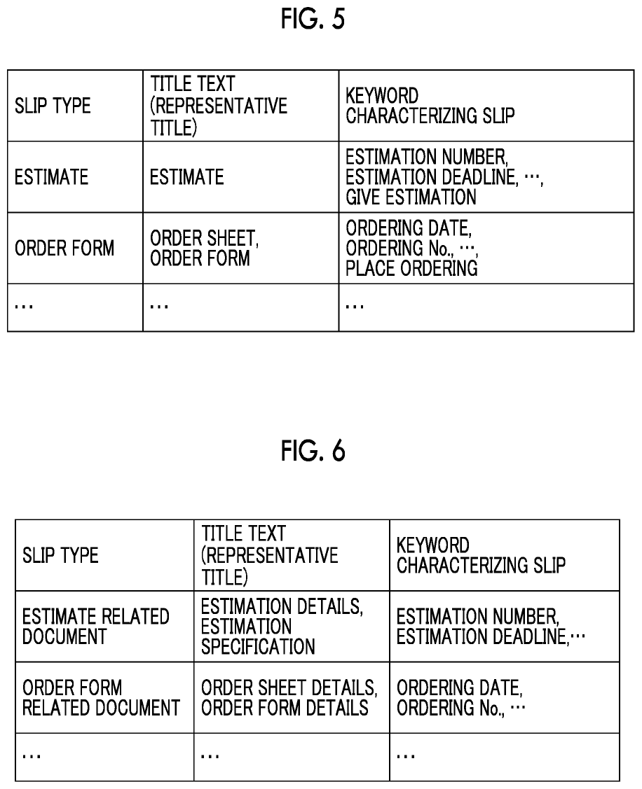

FIG. 5 is a diagram showing an example of a table (hereinafter, referred to as a slip type table) that defines the types of slips used in the information processing apparatus 10 according to the present exemplary embodiment. The slip type table shown in FIG. 5 is stored in a storage unit such as the ROM 12 or the storage 14, and is correlated with information regarding the slip type, title text (representative title), and a keyword that characterizes the slip. For example, information in which the slip type is “estimate” is correlated with information such as “estimate” as title text (representative title), and information such as “estimation number”, “estimation deadline”, and “gives an estimate” as keywords that characterize the slip. In a case where a title extracted from a scanned image does not correspond to the slip type table, “other” information may be defined as the slip type in the scanned image.

The slip type table is not limited to a text indicating a representative title as title text. For example, as shown in FIG. 6, a table including a related title related to a representative title may be included. For example, information such as “estimate-related document” related to the slip type such as “estimate” is correlated with information such as “estimation details” or “estimation specification” as title text (representative title), and information such as “estimation number”, “estimation deadline”, . . . as keywords that characterize the slip.

On the other hand, a page including a representative title and a page following the page are likely to have relevance. Therefore, in the present exemplary embodiment, the relevance between scanned images is specified by using the feature information extracted from each of the scanned images. Specifically, values of the attribute information of the first scanned image and the second scanned image are compared to derive information including the presence or absence of relevance.

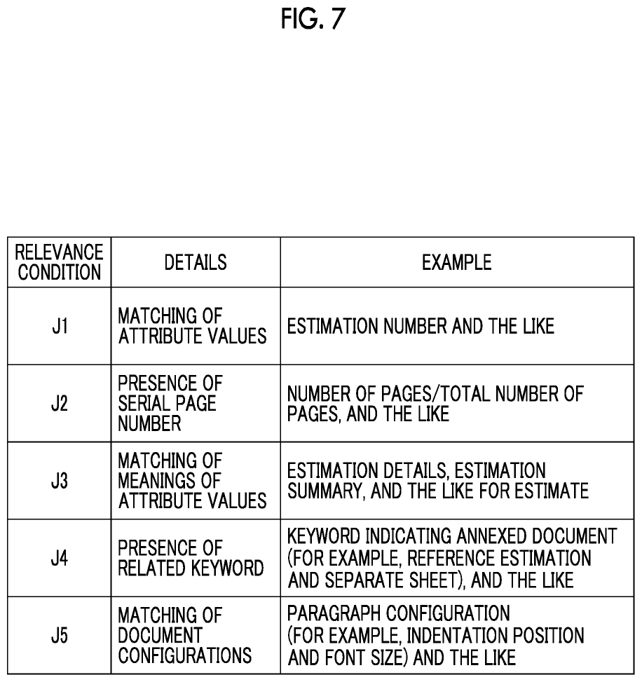

FIG. 7 is a diagram showing an example of a table (hereinafter, referred to as relevance condition table) in which conditions related to relevance used in the information processing apparatus 10 according to the present exemplary embodiment are defined. The relevance condition table shown in FIG. 7 is stored in a storage unit such as the ROM 12 or the storage 14, and is correlated with information such as an identifier of a relevance condition, details of the relevance condition, and an example of the relevance condition. For example, a condition of which an identifier is “J1” is correlated with information indicating that a matching “attribute value” as the details, and information indicating “estimation number” as a target of the attribute value as the example.

The relevance condition table may store at least details of the relevance conditions.

In the example shown in the state 52 in FIG. 4, the document bundle 60 in which each page is developed is shown.

In this state 52, the slip type of each page is specified by using the above slip type table (FIGS. 5 and 6), and relevance of each page is specified by using the relevance condition table (FIG. 7). Specifically, a page including a representative title (that is, “estimate”) extracted from the scanned image 60A and the scanned image 60C is specified as a division candidate, and a boundary 70 is set. The scanned image 60A and the scanned image 60B have relevance. That is, since the attribute value 62A (estimation details), which is the title of the scanned image 60B, indicates that the document is an annex to the scanned image 60A, the scanned image 60A and the scanned image 60B have relevance. The scanned image 60C and the scanned image 60D also have relevance. That is, since the attribute value 62C (an indentation position, a font size, and the like) which is a document configuration of the scanned image 60C matches the attribute value 62D which is a document configuration of the scanned image 60D, the scanned image 60C and the scanned image 60D are specified to have relevance. Attribute values that are document configurations are not limited to being exactly the same. For example, it may be said that attribute values match each other in a case where the attribute values are within a predetermined allowable range.

Next, in the example shown in the state 54, a division candidate bundle is generated by combining a plurality of scanned images divided by the boundary 70. Specifically, as the division candidate bundle, a first document bundle 60-1 in which the scanned image 60A and the scanned image 60B are combined, and a second document bundle 60-2 in which the scanned image 60C and the scanned image 60D are combined are generated. The first document bundle 60-1 and the second document bundle 60-2 are divided from the document bundle 60. That is, the document bundle 60 is divided into the first document bundle 60-1 and the second document bundle 60-2 as a document bundle of the slip type designated by the user.

Incidentally, for a plurality of division candidate bundles obtained through division, the user may want to collect some of the division candidate bundles. For example, there may be a case where a plurality of division candidate bundles are related to each other for the user and are wanted to be generated as one bundle. The user may want to adjust a position of a boundary for a division candidate.

Therefore, in the present exemplary embodiment, the information processing apparatus 10 is configured such that a position of a boundary for generating a division candidate bundle can be adjusted. As will be described later in details, the adjustment of a position of a boundary may be processed by a predefined set value or may be processed according to an instruction from the user.

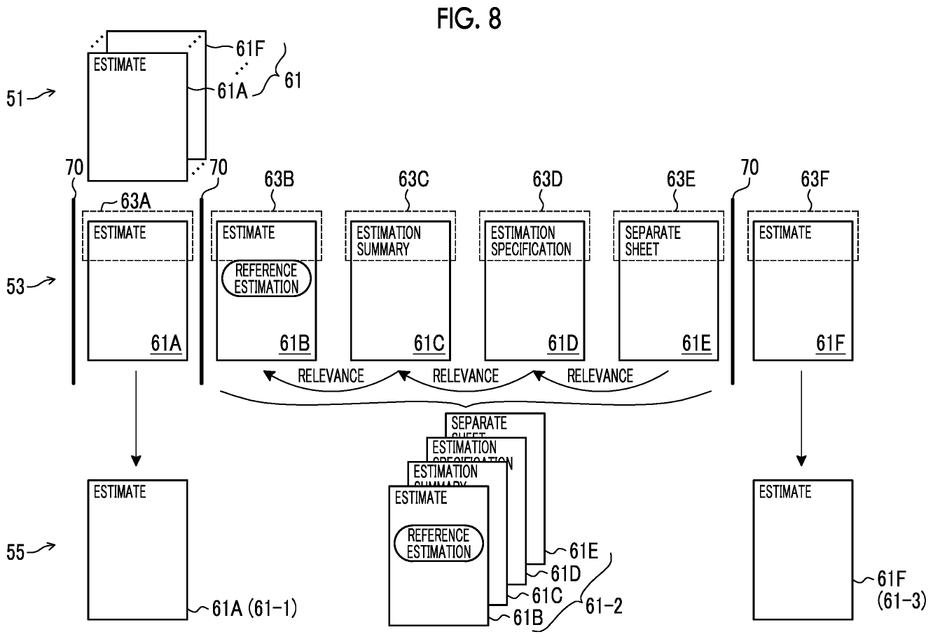

Next, the information processing according to the present exemplary embodiment will be described with reference to FIGS. 8 to 10. Here, information processing including adjusting a position of a boundary for a division candidate will be described. FIGS. 8 to 10 are schematic diagrams showing a flow of information processing executed by the information processing apparatus 10. The information processing according to the present exemplary embodiment described above includes three types of processes as an example. FIGS. 8, 9, and 10 respectively show a process 1, a process 2, and a process 3 as the information processing.

Details of each of the processes 1, 2, and 3 are as follows. As will be described later in details, a division position determination process may be designated by a user each time a division process according to the present exemplary embodiment is performed, or a predetermined process may be automatically executed.

Process 1

FIG. 8 shows a state related to documents in the process 1.

The process 1 is a process of setting documents (scanned images) having relevance as one division candidate bundle. A state 51 is a state related to a document bundle, that is, a document bundle in which a plurality of scanned images are collected, and a document bundle 61 including six scanned images 61A to 61F is shown. A state 53 indicates a state between the scanned images having relevance in the document bundle 61. A state 55 indicates a state in which the scanned images having relevance are individually integrated into a division candidate bundle.

In the process 1, first, feature information is extracted from each of the scanned images 61A to 61F shown in the state 51, and the relevance between the scanned images is derived by using the extracted feature information. That is, as shown in the state 53, the title extraction process described above is executed, and a boundary for a division candidate to be divided into a plurality of division documents as different documents is set between a page including a representative title and the previous page. In a case where the representative title in the scanned image matches the slip type designated by the user, the boundary 70 for the division candidate is set between the page including the representative title and the previous page. The relevance between the scanned images is specified by using the feature information extracted from each of the scanned images.

Specifically, the pages of the scanned images 61A, 61B, and 61F including the slip type (here, “estimate”) designated by the user as a representative title are specified as division candidates, and the boundary 70 is set. The scanned images 61B to 61E have relevance. That is, since the attribute values 63C to 63E of the scanned images 61C to 61E indicate that the scanned images 61C to 61E are documents annex to the scanned image 61B according to the attribute value 63B (estimate) indicated by the title, the scanned images 61C to 61E are specified to have relevance to the scanned images 61B.

Information indicating the above relevance is stored in the storage unit in correlation with the scanned image. For example, new information (an example of scanned image group information) indicating the document bundle 61 is generated by correlating the information indicating the relevance degree with each scanned image in the information indicating the document bundle 61 including a plurality of scanned images (an example of a scanned image group) and is stored in the storage unit. Since the new information includes the relevance of other scanned images for each scanned image, by using the information indicating the relevance in the new information, scanned images having relevance from the document bundle 61 can be divided as a division candidate bundle.

The document bundle 61 including a plurality of scanned images is an example of a scanned image group of the present disclosure, and the new information indicating the document bundle 61 is an example of scanned image group information of the present disclosure.

As shown in the state 55, a division candidate bundle is generated by combining a plurality of scanned images divided by the boundary 70. Specifically, as the division candidate bundle, a first document bundle 61-1 by the scanned image 61A, a second document bundle 61-2 in which the scanned image 61E is combined from the scanned image 61B, and a third document bundle 61-3 by the scanned image 61F are generated. The first document bundle 61-1, the second document bundle 61-2, and the third document bundle 61-3 are divided from the document bundle 61.

Process 2

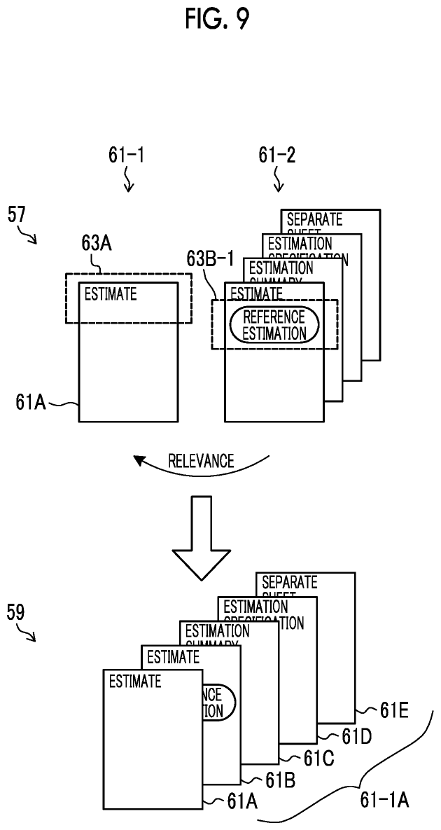

FIG. 9 shows a state related to documents in the process 2.

The process 2 is a process of integrating division candidate bundles having relevance into one document bundle for division candidate bundles individually collected in the process 1. A state 57 is a state showing the relevance between the first document bundle 61-1 and the second document bundle 61-2 among the division candidate bundles divided from the document bundle 61. A state 59 indicates a state in which the division candidate bundles having relevance are integrated into a division candidate bundle.

In the process 2, first, pieces of attribute information or the like of the division candidate bundles are compared, and the relevance between the division candidate bundles is derived. That is, the relevance between the division candidate bundles is specified using the above relevance condition table (FIG. 7). Specifically, the relevance between the division candidate bundles is specified by comparing the attribute value indicating the feature of the first document bundle 61-1 and the attribute value indicating the feature of the second document bundle 61-2. As shown in the state 57, the attribute value 63A indicating the title (estimate) of the scanned image 61A of the first document bundle 61-1 and the attribute value 63B-1 indicating the value (reference estimation) of the attribute information of the scanned image 61B are compared, and the first document bundle 61-1 and the second document bundle 61-2 are specified to have relevance.

In the process of comparing between the division candidate bundles, any scanned image in the division candidate bundle may be used. That is, in the process of comparison, it is sufficient that the relevance between the division candidate bundles can be specified, and relevance is not limited to the relevance between consecutive scanned images. Information that is a target of a comparison process between division candidate bundles is not limited to the information of each scanned image. For example, information for comparison may be derived from a division candidate bundle and used. In the comparison process, in addition to attribute information, configuration information may be used.

Next, in the process 2, in a case where the relevance between the division candidate bundles is specified, the first document bundle 61-1 and the second document bundle 61-2 are integrated as shown in the state 59 such that the division candidate bundle 61-1A is generated. On the other hand, in a case where the relevance between the division candidate bundles is not specified, the first document bundle 61-1 and the second document bundle 61-2, which are the division candidate bundles, are not integrated, and the first document bundle 61-1 and the second document bundle 61-2 are maintained.

Process 3

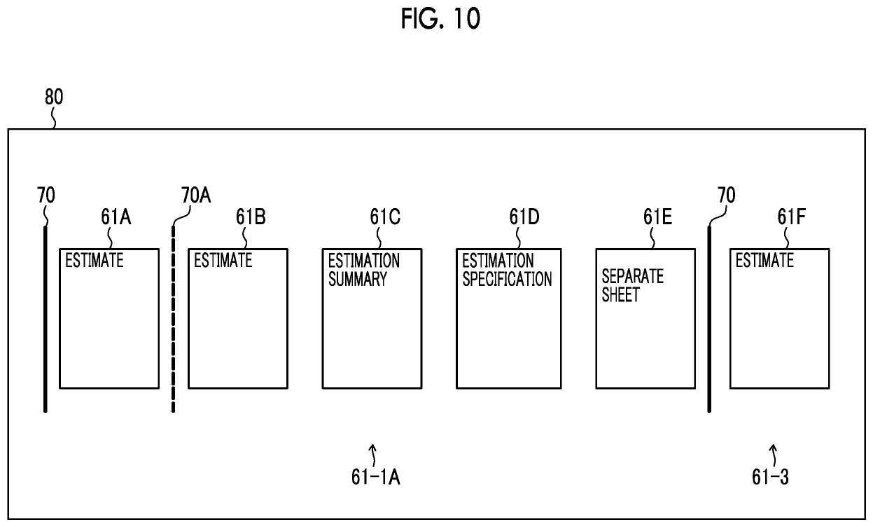

FIG. 10 shows a state related to documents in the process 3.

The process 3 is a process including executing, as necessary, a process of causing the user to check a position of a boundary for division and the user to correct the boundary for the document bundle integrated in the process 2. FIG. 10 shows an example of a screen 80 in the UI 16 for user checking regarding a position of a boundary for division.

In the process 3, first, all the document bundles including the integrated division candidate bundle are developed for each scanned image and displayed on the UI 16. The process of developing a document bundle into scanned images may be limited to the integrated division candidate bundle. The UI 16 also displays the boundary 70 stored in association with the scanned image. Each of the scanned images included in the document bundle is correlated with each of attribute information, configuration information, and information indicating relevance including at least the presence or absence of relevance. Here, in the division candidate bundle 61-1A, the relevance between the division candidate bundles is specified in the above process 2, and the first document bundle 61-1 and the second document bundle 61-2 are integrated, and thus the boundary 70 is erased between the scanned image 61A and the scanned image 61B. The erased boundary 70 may be displayed as a boundary 70A different from the boundary 70 to indicate that the boundary 70 has been erased. In the example shown in FIG. 10, a line type is applied as an example of a different form, and the boundary 70 is represented by a solid line and the boundary 70A is represented by a dotted line. As another example of the different form, a line color such as using a plurality of colors and a line shape such as a straight line and a wavy line may be applied. By displaying the boundary 70A, the user can confirm that the division candidate bundles have been integrated in the information processing apparatus 10.

After confirming the scanned image designated as a candidate divided by the boundary 70 displayed on the UI 16, the user executes a process based on the confirmation result and gives an instruction for determining a position of the boundary 70.

In the process 3, regarding the displayed boundary 70, a correction process is performed on a position of the boundary 70 displayed on the screen 80 by accepting changes due to movement, deletion, and addition. After that, information indicating results of performing changes due to maintenance, movement, deletion, and addition change on the position of the boundary 70 is acquired. Information indicating a result of the above correction process may be corrected by updating information regarding the boundary 70, or new information may be generated and stored.

On the basis of the acquired information, a process of reflecting the user's instruction is executed. As the process, at least one of a storage process of storing information obtained through the above process of maintaining or changing the position of the boundary 70, or a storage process of dividing a target document bundle by using the obtained information and storing the division result in a storage unit or the like is applied. The storage process is a process of storing information regarding a position of the boundary 70 after checking by the user in association with a scanned image as a determined position of the boundary 70. The other storage process is a process of generating information indicating each of a plurality of divided documents into which a document bundle is divided according to the determined position of the boundary 70 and storing the information in a storage unit or the like. The divided document to be stored in the storage unit or the like may be only a document that matches the slip type designated by the user.

In the above process 3, in a case where the user does not need to check a boundary and adjust a position of the boundary, the processes related to checking of the boundary and position adjustment of the boundary may be omitted. The process 3 may be executed according to conditions regarding checking and correction predefined by the user. As the conditions for the checking and correction, a condition or the like indicating that a division candidate bundle set according to the type of slip is determined as a new document bundle may be applied.

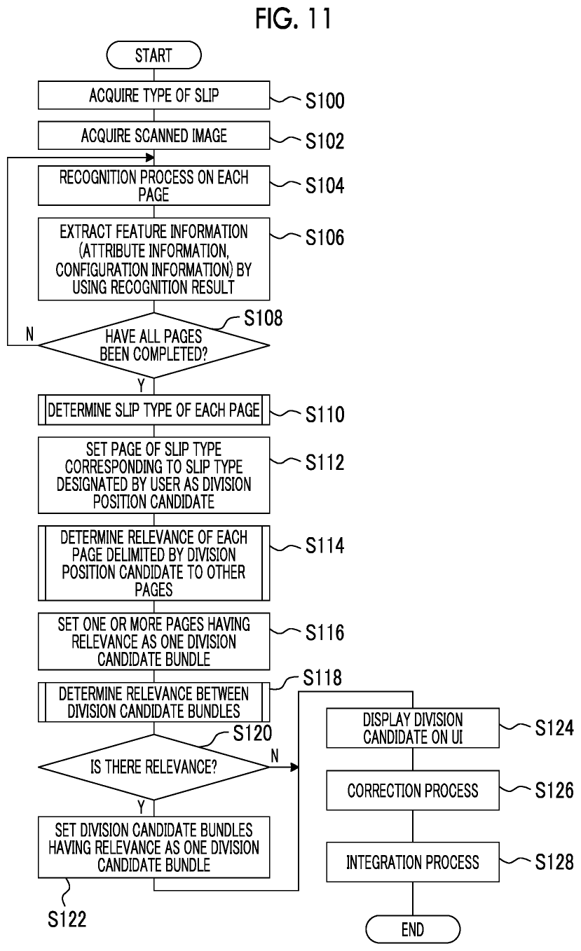

Next, a division process executed by the information processing apparatus 10 will be described with reference to FIGS. 11 to 13. The division process is a process of dividing a document bundle into document bundles having relevance, and FIG. 11 is a flowchart showing a flow of a process of a division process program as information processing according to the present exemplary embodiment. The division process program is stored in a storage unit such as the ROM 12 or the storage 14, and the CPU 11 reads the program from the storage unit, loads the program to the RAM 13 and the like, and executes the program. The division process program may be supplied from the outside via the reception unit 15 or the communication unit 17.

As shown in FIG. 11, in step S100, information indicating the type of slip set as a division target is acquired from a document bundle. As the information indicating the type of slip, information input to the UI 16 through the user's operation may be acquired, or information acquired from the outside via the reception unit 15 or the communication unit 17 may be acquired. In the present exemplary embodiment, information input to the UI 16 and specified by the user is assumed to be acquired.

Next, in step S102, a plurality of scanned images included in a document bundle are acquired.

In step S104, a recognition process is executed on all of the plurality of scanned images, that is, on each of the plurality of scanned images.

In step S106, feature information including attribute information and configuration information is extracted by using the recognition result in step S104.

In step S108, it is determined whether or not the process on all pages (all scanned images) has been completed by determining whether the current page is the last page of the plurality of scanned images, and in a case of a negative determination, the process returns to step S104. On the other hand, in a case where the recognition process and the feature information extraction process on all pages (all scanned images) have been completed and an affirmative determination is made in step S108, the process proceeds to step S110 and execution of the above process 1 is started.

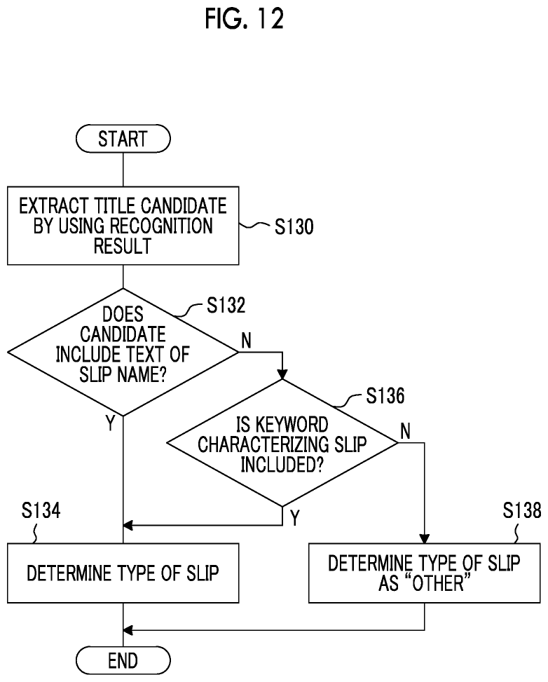

In step S110, the slip type of each scanned image is determined. As the process of determining the slip type, a slip type determination process (refer to FIG. 12) that will be described later in detail is executed. The determination process stores at least a page from which a title has been extracted. The page from which the title has been extracted is, for example, any of the first pages (61A, 61B, and 61F) of the respective division candidate bundles 61-1, 61-2, and 61-3 in FIG. 8.

In step S112, among the pages determined in step S110, the page of the slip type corresponding to the slip type specified by the user acquired in step S100 is set as a candidate of a division position. The boundary 70 is set between the page set as the candidate of the division position and the previous page.

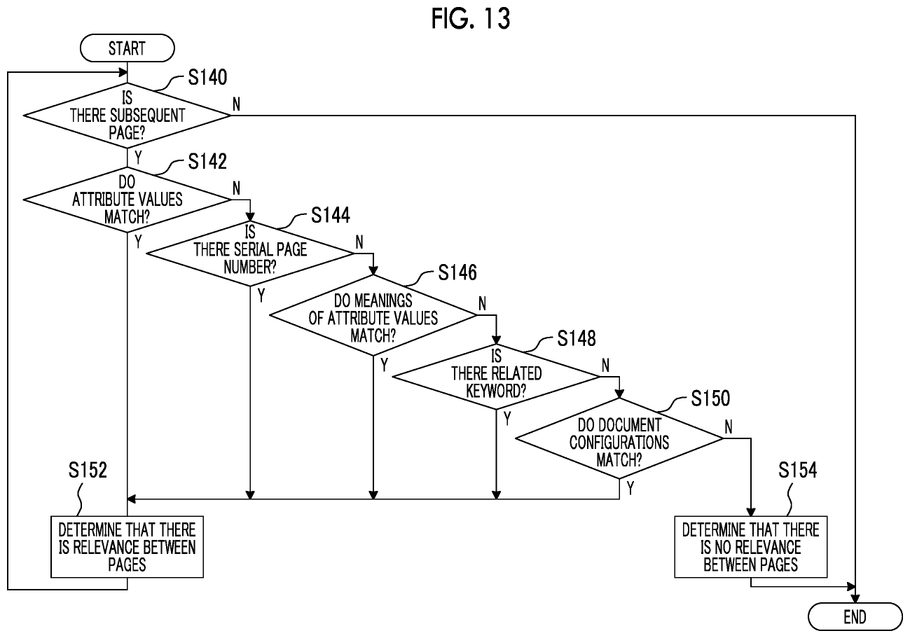

In step S114, it is determined that each page delimited by the page set as the candidate of the division position has relevance to another page. For example, the relevance between the page of the candidate of the division position and a page of the subsequent other scanned image is determined. As a process of determining the relevance, a scanned image determination process (refer to FIG. 13) that will be described later in detail is executed. Information indicating the relevance in the determination result is stored in correlation with each scanned image, that is, another scanned image.

In step S116, one or more pages (scanned images) having relevance are set as one division candidate bundle. In a case where the process of setting the pages (scanned image) having the relevance as one division candidate bundle has been completed, the process proceeds to step S118, and execution of the above process 2 is started.

In step S118, the relevance of a set plurality of division candidate bundles is determined. The process of determining the relevance of a plurality of division candidate bundles may be performed in the same manner as the above relevance determination process (refer to FIG. 13) by using, for example, the last scanned image of a first division candidate bundle and the first scanned image of a second division candidate bundle following the first division candidate bundle. The determination result is stored in correlation with the division candidate bundle, for example, the first scanned image of the division candidate bundle as information indicating the relevance in the determination result.

In step S120, it is determined whether or not there are a plurality of division candidate bundles having relevance on the basis of the information stored in correlation with the division candidate bundle, and in a case of an affirmative determination, the process proceeds to step S122, and in a case of a negative determination, the process proceeds to step S124.

In step S122, a plurality of division candidate bundles having relevance are set as one division candidate bundle on the basis of the information stored in correlation with the division candidate bundle. In a case where the process of setting the division candidate bundle having relevance as one division candidate bundle has been completed, the process proceeds to step S124, and execution of the above process 3 is started.

In step S124, the division result is displayed on the UI 16 (FIG. 8).

In step S126, a correction process is executed. That is, the correction process is performed on the boundary 70 displayed on the UI 16 such that a boundary is shown according to changes by accepting the changes due to movement, deletion, and addition regarding the position of the boundary 70 for which an instruction is given from the user.

In step S128, information after checking by the user is determined by the user, an integration process of integrating related scanned images is executed, and the division process program is finished. The integration process includes reintegrating related scanned images in the document bundle 61 into a division document bundle by the boundary 70 after maintenance or correction.

The integration process of reintegrating a division document bundle is not limited to integrating related scanned images, but may be an information generation process such as generating information for division according to a position of the boundary 70 after checking by the user. For example, the integration process may be a process of generating information for dividing the document bundle 61 into division document bundles by the boundary 70 after maintenance or correction. That is, information regarding the position of the boundary 70 after checking by the user may be stored in association with a scanned image as a determined position of the boundary 70.

Next, with reference to FIG. 12, a slip type determination process related to step S110 in FIG. 11 will be described. The slip type determination process is a process of determining the slip type of each scanned image, and FIG. 12 is a flowchart showing a flow of a process of a slip type determination process program. The slip type determination process program is stored in a storage unit such as the ROM 12 or the storage 14, and the CPU 11 reads the program from the storage unit, loads the program to the RAM 13 and the like, and executes the program.

As shown in FIG. 12, in step S130, title candidates are extracted using the recognition result of the feature information. That is, the title (attribute information) extracted through the title extraction process is extracted as a title candidate. For example, in the scanned images 61A and 61B of FIG. 10, “estimate” is extracted.

In step S132, it is determined whether or not the title candidate includes the text of the slip name. That is, it is determined whether or not the extracted title candidate is included in the title text in the table (FIGS. 5 and 6). In a case of an affirmative determination, the process proceeds to step S134, and in a case of a negative determination, the process proceeds to step S136. For example, in the scanned image 61 in FIG. 10, since the table shown in FIG. 5 includes “estimate”, an affirmative determination is made.

In step S134, a process of determining the type of slip is executed, and present process routine is finished. In the process of determining the type of slip, the slip type of title text matching the title candidate is determined in the table (FIGS. 5 and 6). For example, in the scanned image 61 in FIG. 10, “estimate” is determined as the slip type.

In step S136, it is determined whether or not a keyword that characterizes the slip is included. That is, it is determined whether or not the extracted title candidate is included in the keyword that characterizes the slip in the table (FIGS. 5 and 6). In a case of an affirmative determination, in step S134, the slip of the keyword that characterizes the slip type that matches the title candidate is determined, and present process routine is finished.

On the other hand, in a case of a negative determination, the process proceeds to step S138.

In step S138, the type of the slip is determined to be “other”, and present process routine is finished.

Next, with reference to FIG. 13, a scanned image relevance determination process in step S114 in FIG. 11 will be described. The scanned image relevance determination process is a process of determining the relevance of each page delimited by a page set as a candidate of a division position to other pages, and FIG. 13 is a flowchart showing a flow of a process of a scanned image relevance determination process program. The scanned image relevance determination process program is stored in a storage unit such as the ROM 12 or the storage 14, and the CPU 11 reads the program from the storage unit, loads the program to the RAM 13 and the like, and executes the program.

As shown in FIG. 13, in step S140, it is determined whether or not there is a subsequent scanned image (page). In A case of an affirmative determination, the process proceeds to step S142, and in a case of a negative determination, the present process routine is finished. The determination is a process of determining whether or not there is a scanned image that is a target for which the relevance is determined. In the present exemplary embodiment, as an example, it is determined whether or not there is a subsequent scanned image (page) for a plurality of scanned images that are targets for which the relevance is determined. For example, it is determined whether or not there is a subsequent page by determining whether or not the page (scanned image) that is the division position candidate has a subsequent page (scanned image). That is, one page delimited by the page set as the division position candidate will be referred to as a first scanned image, and the subsequent page following the first scanned image will be referred to as a second scanned image. When the first scanned image is set in order from the first page, in a case where the second scanned image is present, an affirmative determination is made, and in a case where the second scanned image is not present, a negative determination is made.

In step S142, it is determined whether or not the attribute values of the attribute information match by determining whether or not the condition J1 (refer to the relevance condition table shown in FIG. 7) is satisfied. That is, in a case where the attribute values of the attribute information of the first page (scanned image) and the subsequent second page (scanned image) match, an affirmative determination is made, and in a case where the attribute values do not match, a negative determination is made. In the case of an affirmative determination, the process proceeds to step S152, and in the case of a negative determination, the process proceeds to step S144.

In step S144, it is determined whether or not there is a serial page number as the attribute value of the attribute information by determining whether or not the condition J2 is satisfied. In a case where there is a serial page number, an affirmative determination is made, and in a case where there is no serial page number, a negative determination is made. In the case of an affirmative determination, the process proceeds to step S152, and in the case of a negative determination, the process proceeds to step S146.

In step S146, it is determined whether or not the meanings of the attribute values of the attribute information match by determining whether or not the condition J3 is satisfied. In a case where the meanings match, an affirmative determination is made, and in a case where the meanings do not exist, a negative determination is made.

In the case of an affirmative determination, the process proceeds to step S152, and in the case of a negative determination, the process proceeds to step S148.

In step S148, it is determined whether or not there is a keyword indicating an annexed document in the attribute value of the attribute information in the second scanned image by determining whether the condition J4 is satisfied.

In a case where there is a keyword, an affirmative determination is made, and in a case where there is no keyword, a negative determination is made. In the case of an affirmative determination, the process proceeds to step S152, and in the case of a negative determination, the process proceeds to step S150.

In step S150, it is determined whether or not the document configurations match by determining whether or not the condition J5 is satisfied. That is, it is determined that the pieces of configuration information indicating page configurations such as a font size and a ruled line match between the first page (scanned image) and the subsequent second page (scanned image), and in a case where the pieces of configuration information match, an affirmative determination is made, and in a case where the pieces of configuration information do not match, a negative determination is made. In the case of an affirmative determination, the process proceeds to step S152, and in the case of a negative determination, the process proceeds to step S154.

In step S152, it is determined that there is “relevance” between the scanned images, the determination result is stored in correlation with the scanned images, and the process returns to step S140.

In step S154, it is determined that there is “no relevance” between the scanned images, the determination result is stored in correlation with the scanned images, and the present process routine is finished. After the determination of no relevance, by finishing the present process routine, information indicating the determination result of “relevance” can be stored in correlation with only consecutive scanned images having relevance. After the determination of no relevance, the process may return to step S140 without finishing the present process routine. In a case where the process returns to step S140 after the determination of no relevance, the above determination process can be executed on all the pages delimited by the page set as the candidate of the division position.

Although the process of determining the relevance of continuous scanned images has been described above, the scanned images to be determined are not limited to continuous. For example, by setting the page (scanned image) that is the division position candidate as the first scanned image, and any one of other scanned image by the page set as the candidate of the division position as the second scanned image, relevance between the scanned images may be determined.

In the above description, the case where the boundary 70 is displayed and the user is made to recognize a division candidate bundle has been described, but the present exemplary embodiment is not limited to displaying the boundary 70. For example, instead of the boundary 70, an image such as a predetermined mark may be used, and a display form of a scanned image of a division candidate (a first scanned image of a division candidate bundle) may be displayed differently from other scanned images. As an example of the display form, an image density such as grayout, a line type and a color of an outer border of a scanned image, and the like may be applied.

### Second Exemplary Embodiment

Next, a second exemplary embodiment according to the present disclosure will be described. Since the second exemplary embodiment has the same configuration as that in the first exemplary embodiment, the identical parts are given the identical reference numerals, detailed description thereof will be omitted, and different parts will be described.

The above condition for specifying relevance (FIG. 7) corresponds to at least one condition, and thus the relevance between the scanned images is specified. On the other hand, for example, a plurality of similar scanned images may be included, and a scanned image to be divided may be included in one division candidate bundle. Therefore, in the present exemplary embodiment, the feature information extracted from each of the scanned images is used to derive a relevance degree indicating the degree of relevance as the information indicating the relevance, and the relevance is specified on the basis of the derived relevance degree.

The relevance degree is an index that quantifies the relevance between scanned images, and indicates information that increases as the relevance of the second scanned image to the first scanned image, that is, the relevance of feature information of the scanned images increases. By using the derived relevance degree, it is determined that there is the relevance between scanned images having a relevance degree equal to or more than a predetermined threshold value, and it is determined that there is no relevance between scanned images having a relevance degree less than the threshold value. Consequently, it is possible to improve the accuracy of specifying the relevance between scanned images.

The relevance degree may be derived by using a predefined conditional expression. The relevance degree is derived on the basis of a ratio at which each of the plurality of weighted relevance conditions is satisfied. An example of a conditional expression for deriving the relevance degree is shown below. A relevance degree Jz indicates a sum total of a weight W preset for each condition multiplied by a ratio R. Numerical values indicating the conditions in the relevance condition table are given after respective symbols to the weight W and the ratio R in the expression.

Jz=Jx/Jy where, Jx=W1·(R1/3)+W2·R2+W3·R3+W4·R4+W5·R5, Jy=W1+W2+W3+W4+W5

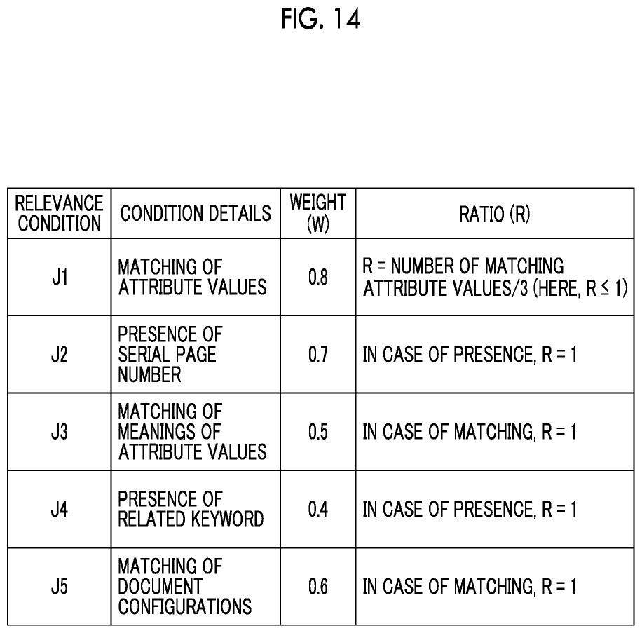

FIG. 14 is a diagram showing an example of a table (hereinafter, referred to as a relevance degree table) in which conditions for specifying relevance are determined by using the relevance degree. The conditional expression and the relevance degree table shown in FIG. 14 are stored in a storage unit such as the ROM 12 or the storage 14, and in the relevance degree table, a relevance condition identifier is correlated with information such as details, a weight, and ratio of a relevance condition in the relevance degree table. For example, in the first condition, the identifier “J1” is correlated with information such as the details “matching of attribute values”, the weight W, and the ratio R. In the first condition J1, the weight W1 of “0.8” is correlated with a value obtained by dividing a total number of scanned images matching the ratio R1 by a predefined number (for example, 3).

The condition of R1≤1 is also set in the ratio R1 of the condition J1. The second condition J2 is applied in a case where “there is a serial page number” in the attribute information, and the weight W2=0.7 and the ratio R2=1. In the same manner for the subsequent conditions, the third condition J3 is applied in a case where “the meanings of the attribute values match”, and the weight W3=0.5 and the ratio R3=1. The fourth condition J4 is applied in a case where “there is a related keyword”, and the weight W4=0.5 and ratio R4=1, and the fifth condition J5 is applied in a case where “document configurations match” and the weight W5=0.5 and the ratio R5=1.

For example, in a case where there are two matching attribute values, serial pages are present, and the document configurations match between the scanned images, the conditions J1, J2, and J5 are applied, and the numerical value “0.61111” is derived as the relevance degree by using the above conditional expression. In a case where these conditions are used as a reference, it is possible to determine the presence or absence of relevance between the scanned images by setting a threshold value to 0.6. The threshold value may be determined from numerical values obtained by the test and empirical numerical values.

Jz={0.8·(3/2)+0.7·1+0.6·1}/(0.8+0.7+0.5+0.4+0.6)

By setting each of the above weights W to 1 and setting the threshold value to 1, it is possible to apply to determination of the presence or absence of relevance between scanned images corresponding to the condition matching according to the first exemplary embodiment.

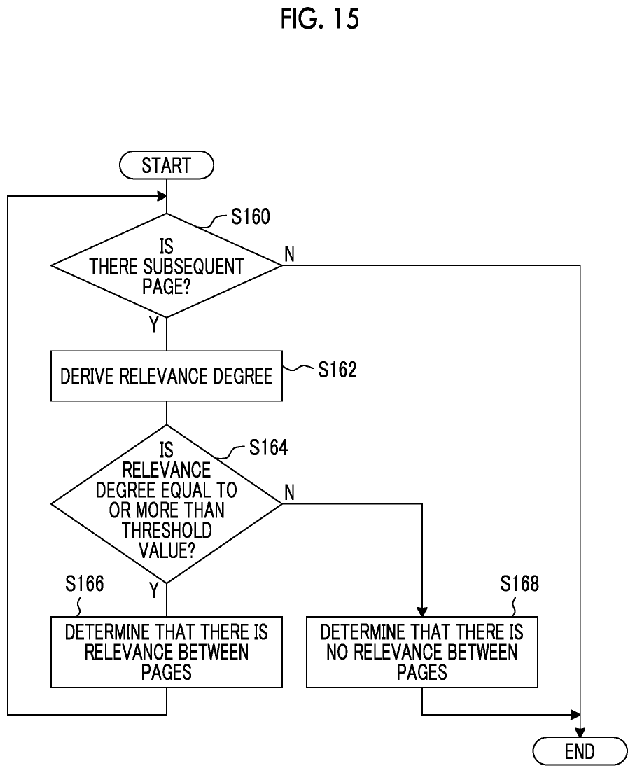

Next, with reference to FIG. 15, a scanned image relevance determination process according to the present exemplary embodiment will be described. FIG. 15 is a flowchart showing a flow of a process of a scanned image relevance determination process program. The process shown in FIG. 15 is executed in place of the process shown in FIG. 13 as the process in step S114 shown in FIG. 11.

As shown in FIG. 15, in step S160, it is determined whether or not there is a subsequent scanned image (page), and in a case of an affirmative determination, the process proceeds to step S162, and in the case of a negative determination, the present process routine is finished. Since the determination is the same process as in step S140 in FIG. 13, the description thereof will be omitted.

In step S162, the relevance degree is derived. That is, the relevance degree Jz is derived according to the above conditional expression by using the relevance condition table (FIG. 14).

In step S164, it is determined whether or not the derived relevance degree Jz is equal to or more than a predetermined threshold value. In a case where the relevance degree Jz is equal to or more than the threshold value, an affirmative determination is made, and in a case where the relevance degree Jz is less than the threshold value, a negative determination is made. In the case of an affirmative determination, the process proceeds to step S166, and in the case of a negative determination, the process proceeds to step S168.

In step S166, it is determined that there is “relevance” between the scanned images, the determination result is stored in correlation with the scanned images, and the process returns to step S160. As a result of determining whether or not there is relevance, the relevance degree Jz may be stored in correlation with the scanned images.

In step S168, it is determined that there is “no relevance” between the scanned images, the determination result is stored in correlation with the scanned images, and the present process routine is finished.

The relevance degree derived by using the conditional expression as described above may be presented as information indicating the degree of relevance in step S124 shown in FIG. 11. For example, the boundary 70 is displayed in a display form according to the relevance degree. In the display of the boundary 70, the display form may be changed step by step according to the relevance degree. As an example of the display form, the line type and a color of the boundary 70 may be applied. Consequently, it is possible for a user to check the relevance between division candidate bundles having relevance. That is, by changing the display form step by step according to the relevance degree, it is possible for a user to intuitively check the relevance between division candidate bundles with a degree compared with a case where the common boundary 70 is displayed.

The relevance degree may be used for controlling display of the relevance between scanned images other than the boundary 70 described above. Specifically, it may be applied to the control of displaying the auxiliary line of the display form according to the relevance degree between the scanned images other than the boundary 70. By displaying an auxiliary line, it is possible for a user to check the relevance between scanned images compared with the case where the auxiliary line is not displayed.

The auxiliary line may be presented as auxiliary information to support a user's determination in a case where the user determines to maintain or change a position of the boundary 70.

Other Forms

In the above description, the technique of the present disclosure has been described in detail with respect to a specific exemplary embodiment, but the technique of the present disclosure is not limited to such an exemplary embodiment, and various other techniques can be made within the scope of the technique of the present disclosure. The configuration of the information processing apparatus 10 described in the above exemplary embodiments is only an example, and may be changed depending on the situations within the scope without departing from the spirit.

The flow of the process of the program described in the above exemplary embodiments is also an example, and unnecessary steps may be deleted, new steps may be added, or the processing order may be changed within the scope without departing from the spirit.

In the above-described respective exemplary embodiments, the process performed by executing the program stored in the storage unit has been described, but the process of the program may be realized by hardware.

In the above-described respective exemplary embodiments, a description has been made of an aspect in which the information processing program is stored (installed) in the ROM 12 or the storage 14 in advance, but this is only an example. The program may be provided in a form of being recorded on recording media such as a compact disk read only memory (CD-ROM), a digital versatile disk read only memory (DVD-ROM), and a Universal Serial Bus (USB) memory. The program may be provided in a form of being downloaded from an external apparatus via a network.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An information processing apparatus comprising:
a processor configured to:
acquire a plurality of scanned images obtained by scanning a bundle of paper media having a plurality of pages;
extract feature information indicating a feature of a scanned image including at least a type of a corresponding document of each scanned image among the plurality of scanned images;
derive, on the basis of the feature information of each of the plurality of scanned images, information that indicates relevance and increases as the relevance related to the feature information between a first scanned image and a second scanned image scanned later than the first scanned image among the plurality of scanned images, increases;
correlate the information indicating the relevance with the second scanned image; and
generate scanned image group information indicating the plurality of scanned images including the scanned image with which the information indicating the relevance is correlated.

2. The information processing apparatus according to claim 1, wherein
the information indicating the relevance indicates one of presence or absence of relevance.

3. The information processing apparatus according to claim 1, wherein
the information indicating the relevance is a relevance degree indicating a degree that increases as the relevance increases.

4. The information processing apparatus according to claim 3, wherein
a scanned image bundle based on a plurality of scanned images including the second scanned image with which a relevance degree equal to or more than a predefined threshold value is correlated and the first scanned image for the second scanned image is divided on the basis of the relevance degree included in the scanned image group information.

5. The information processing apparatus according to claim 1, wherein
designated feature information that is designated by a user is further acquired, and
the feature information corresponding to the acquired designated feature information is extracted.

6. The information processing apparatus according to claim 2, wherein
designated feature information that is designated by a user is further acquired, and
the feature information corresponding to the acquired designated feature information is extracted.

7. The information processing apparatus according to claim 3, wherein
designated feature information that is designated by a user is further acquired, and
the feature information corresponding to the acquired designated feature information is extracted.

8. The information processing apparatus according to claim 4, wherein
designated feature information that is designated by a user is further acquired, and
the feature information corresponding to the acquired designated feature information is extracted.

9. An information processing apparatus comprising:
a processor configured to:
acquire a plurality of scanned images obtained by scanning a bundle of paper media having a plurality of pages;
extract feature information indicating a feature of a scanned image including at least a type of a corresponding document of each scanned image among the plurality of scanned images;
derive, on the basis of the feature information of each of the plurality of scanned images, information that indicates relevance and increases as the relevance related to the feature information between a first scanned image and a second scanned image scanned later than the first scanned image among a plurality of scanned images, increases; and
divide a scanned image bundle based on a plurality of scanned images including the second scanned image with which information indicating relevance equal to or more than a predefined threshold value is correlated and the first scanned image for the second scanned image on the basis of the information indicating the relevance.

10. The information processing apparatus according to claim 9, wherein
designated feature information that is designated by a user is further acquired, and
the feature information corresponding to the acquired designated feature information is extracted.

11. The information processing apparatus according to claim 9, wherein
before the plurality of scanned images are divided, the information indicating the relevance is presented as a candidate in which a magnitude of the relevance is settable, and is updated to new relevance information with a set magnification.

12. The information processing apparatus according to claim 10, wherein
the information indicating the relevance is presented as a candidate in which a magnitude of the relevance is settable, and is updated to new relevance information with a set magnification.

13. The information processing apparatus according to claim 1, wherein
the first scanned image and the second scanned image are consecutively scanned in this order.

14. The information processing apparatus according to claim 2, wherein
the first scanned image and the second scanned image are consecutively scanned in this order.

15. The information processing apparatus according to claim 3, wherein
the first scanned image and the second scanned image are consecutively scanned in this order.

16. The information processing apparatus according to claim 4, wherein
the first scanned image and the second scanned image are consecutively scanned in this order.

17. The information processing apparatus according to claim 5, wherein
the first scanned image and the second scanned image are consecutively scanned in this order.

18. The information processing apparatus according to claim 6, wherein
the first scanned image and the second scanned image are consecutively scanned in this order.

19. The information processing apparatus according to claim 7, wherein
the first scanned image and the second scanned image are consecutively scanned in this order.

20. A non-transitory computer readable medium storing an information processing program causing a computer to execute a process comprising:
acquiring a plurality of scanned images obtained by scanning a bundle of paper media having a plurality of pages;
extracting feature information indicating a feature of a scanned image including at least a type of a corresponding document of each scanned image among the plurality of scanned images;
deriving, on the basis of the feature information of each of the plurality of scanned images, information that indicates relevance and increases as the relevance related to the feature information between a first scanned image and a second scanned image scanned later than the first scanned image among a plurality of scanned images, increases;
correlating the information indicating the relevance with the second scanned image; and
dividing a scanned image bundle based on a plurality of scanned images including the second scanned image with which information indicating relevance equal to or more than a predefined threshold value is correlated and the first scanned image for the second scanned image on the basis of the information indicating the relevance.
